(19) United States
(12) Patent Application Publication
(10) Pub. No.: US 2012/0191265 A1
(43) Pub. Date: Jul. 26, 2012

(54) CONTROL OF UNDERWATER TURBINE

(75) Inventor: John Keir, Singapore (SG)

(73) Assignee: ATLANTIS RESOURCES CORPORATION PTE LIMITED, Singapore (SG)

(21) Appl. No.: 13/321,647

(22) PCT Filed: May 21, 2010
(86) PCT No.: PCT/AU10/00618

§ 371 Date: Mar. 8, 2012

(30) Foreign Application Priority Data
May 22, 2009 (AU) 2009902353

(51) Int. Cl. G06F 1/26; F03B 13/10

(52) U.S. Cl. 700/287; 290/42

(57) ABSTRACT

A system and a method for controlling operation of an underwater power generator is described, as well as computing componentry for controlling the operation of the underwater power generator. The system comprises: meters for measuring selected properties associated with blade speed and inward water flow of the underwater power generator; a drive for altering one or more selected aspects of operation of the underwater power generator; and a data processing apparatus comprising a central processing unit (CPU), a memory operatively connected to the CPU, the memory containing a program adapted to be executed by the CPU, wherein the CPU and/or memory are operatively adapted to receive information from the meters to calculate a Tip Speed Ratio (TSR or λ) and implement an instruction to the drive to change the one or more selected operating parameters of the underwater power generator in response to the calculated TSR or λ.

### FIELD OF THE INVENTION

The invention relates generally to systems and methods suitable for controlling operation of underwater power generation units.

### BACKGROUND TO THE INVENTION

It is known to generate power from flows of water. However, many known systems for generating power from water flows are not easily controlled. In order to connect to an electricity grid and supply power thereto, it is useful to have predictable and controllable power outputs.

Although the flows of water at particular locations generally vary in a predictable manner, usually as tides ebb and flow, these variations change the power which can be extracted from underwater power generation units and the efficiency with which the power is extracted when some components are not infinitely variable or at all in certain ways. Also, there are times when flows change in an unpredictable manner, such as from some frontal, lunar or other kind of unforeseen event. This can increase the water flow in an undesirable fashion, either in terms of a variation in frequency and/or amplitude, with the result being efficiency or componentry being negatively affected.

Furthermore, water environments include unpredictable elements such as large and small marine life, dirt, silt, growths, and other complicating factors. Control systems to date have not been able to deal with these kind of output risk factors.

The present invention seeks to ameliorate one or more of the abovementioned disadvantages.

### DISCLOSURE OF INVENTION

In a first aspect, the present invention provides a system for controlling operation of an underwater power generator, the system comprising:

meters for measuring or indicating selected properties associated with blade or foil speed and inward water flow of the underwater power generator;

a drive for altering operation of the underwater power generator; and

a data processing apparatus comprising a central processing unit (CPU), a memory operatively connected to the CPU, the memory containing a program adapted to be executed by the CPU, wherein the CPU and/or memory are operatively adapted to receive information from the meters to calculate a Tip Speed Ratio (TSR or λ) and implement an instruction to the drive to change an operating parameter of the underwater power generator in response to the calculated TSR or λ.

Preferably the meters include suitable meters for directly or indirectly measuring or indicating blade speed and inward water flow, including tachometers, flow meters, ammeters, voltmeters, power meters, ohmmeters or like others.

The operating parameter which is changed by the drive may include the rotational speed of the blades.

There are some situations in the operation of the system where external power and/or the VSD can be used to initiate or continue rotor rotation at a minimum or desired speed to ensure optimum power generation. The control system may initiate the drawing of power from a power grid to power up the turbine if required.

Preferably, the system controls the turbine to optimize power generation in a given water flow rate. Typically, the flow rate is less than about 10 knots, less than about 8 knots, less than about 6 knots or between about 1 and 5 knots. The water flow rate maybe tidal, river flow, outflow, or current in an ocean or sea. The present invention is particularly suitable for controlling a water turbine installed in an environment with low flow rates of less than about 5 knots to provide optimum power or electricity generation. The system can be used to control a turbine up to about 8 knots.

The turbine may be a track-based turbine or slew-ring turbine, and may be as described in WO 2005/028857, WO 2005/119052 and WO 2007/070935 (Atlantis Resources Corporation Pte Limited).

The turbine, if track-based, may have one power take off running one or more generators or multiple power take offs running multiple generators.

Preferably, other meters are provided to measure activities or quantities such as water flow direction, relative position to water flow, load, torque, height or position in water, rotor blade or foil lift, rotor blade or foil drag, torque, power output, electricity generated, power load, and the like.

Preferably further meters are provided and include: a sonar device for detecting potential or actual obstructions; means for measuring an activity in the form of a current profiler; a thermocouple for measuring the temperature of ambient air or ambient water or motor temperature, or hydraulic oil temperature; a transducer receiving angular or height measurements relating to yaw or linear positioning of the turbine; one or more underwater or above-water cameras for detecting potential or actual obstructions; one or more transducers for measuring turbine speed or power generated, volts generated, phase generated; tide information; a fuse, connection or relay check routine; and combinations thereof.

In preferred embodiments the drive may be one or more of the following: a hydraulic motor for changing a pitch or attack angle of the blades; yaw angle or height of the turbine above sea bed level; a generator or inverter to change a torque input to the turbine to affect its rotational speed; an alarm; and combinations thereof.

Preferably the underwater power generator is in the form of a central axis water turbine which includes: a turbine body having a central axis; a rotor mounted on the turbine body for rotation about the central axis, the rotor comprising a central hub supporting a plurality of blades, each blade extending from a blade root mounted on the hub to a blade tip; a generator driven by the rotor; and may include a housing surrounding the rotor and adapted to direct water flow towards the blades.

Preferably the power generation apparatus includes:

a generator;

a first blade set operatively mounted to the generator for rotation in a selected direction in response to flowing water from a selected direction;

a second blade set operatively mounted to the generator for rotation and operatively connected to the first blade set, the second blade set being disposed coaxially with, and downstream of or in a wake zone of, the first blade set;

wherein the generator is adapted to be driven by at least one of the blade sets, and the generator disposed generally coaxially between the first and second blade sets.

In some arrangements the coaxially-disposed first and second blade sets are mounted on first and second rotors, respectively. In this arrangement, the first and second rotors are preferably mounted on a shaft assembly which comprises operatively coupled or linked rotor shafts connected together so that the second rotor rotates in the same direction as the first rotor.

In other arrangements a clutch or braking arrangement is provided in order to uncouple the first blade set from the second blade set. Therefore in these arrangements, in operation, the second blade set may be locked with a braking apparatus to a stopped position or uncoupled completely and allowed to rotate freely.

In alternative arrangements a coupling apparatus may be provided between the blade sets which drives the second blade set in an opposite direction to that of the first blade set.

In still further embodiments the generator may be driven by a separate generator shaft operatively coupled to the rotor shafts. The generator shaft may be operatively connected to a gearbox so it rotates at a higher or lower rate than the rotor shafts.

Preferably, however, the first and second rotors directly drive a generator and thus are mounted on a common rotor shaft so that they rotate at the same rate. Preferably, the rotors are mounted on the shaft via a hub with an interference fit or a splined connection.

Preferably there are a plurality of blades provided per blade set. There may be any suitable number of blades provided, such as for example between two and ten. In a preferred form, there are provided three blades per blade set. In preferred arrangements the blades of the second blade set are staggered in terms of angular position relative to the first so that the blades of the second set are not directly shadowed by the blades of the first set when rotating on a common shaft. A preferred factor in selecting the rotation direction is blade disposition and in preferred embodiments the angle of attack of the blades is fixed, however, in some embodiments the blades may be variable in pitch.

In a more preferred form, the two blade sets contain the same number of blades with substantially the same profile and size. Thus, in use, one blade set may eclipse the other blade set.

Optionally, blades of one blade set on one rotor may have a different profile from those blades on the blade set of another rotor, but the blades of both blade sets are preferably identical in number, length, cross section and other major characteristics.

Preferably the first and second rotors are separated by any suitable separation distance. In preferred embodiments, the separation distance is at least a distance that the blades would be considered spaced apart from one another than adjacent one another.

Preferably the blade sets are spaced an effective distance apart, and in a wake field or wake zone, and approximately the length of the diameter (d) of the blades.

Testing and modelling indicates that, for optimal operation, an efficient separation distance may vary between about 0.5 d and 10 d.

Advantageously, modelling and testing of preferred embodiments of the present invention indicate that increased power can be gained from a smaller diameter, multiple blade set unit when compared with a larger diameter single blade set unit. These embodiments may reduce cost/kWH significantly.

Preferably the power generation apparatus is suitable for underwater and marine mounting and use.

The rotors preferably include a nose cone mounted on the front of the rotors to reduce drag on the rotors and reduce turbulent water flow. Preferably the nose cone is hollow to provide space for auxiliary systems such as a control system, or reservoirs for auxiliary or even primary systems.

Embodiments including mono-directional blades, as well as bidirectional-bladed embodiments, may include a rotating system to align the blade sets to a tidal flow which may change attack or flow direction from time to time.

Thus, in one embodiment, the arrangement may be such that a turbine head unit, comprising at least a generator and two abovedescribed rotatably mounted blade sets spaced apart along a longitudinal axis is mounted so as to automatically or manually (via electric drive or other means) substantially align itself so that the longitudinal axis of the turbine head unit is parallel with the tidal or attack flow. Thus in this embodiment the turbine head unit is rotatably mounted on a pylon.

Preferably the pylon is substantially vertical, but it may be of any selected suitable orientation, as long as the arrangement is such that the pylon spaces the nacelle from the sea bed a selected distance, far enough to clear the blades from the sea bed when spinning about the rotor. A rotating apparatus is disposed either on the pylon remote from or adjacent the turbine head unit.

The power generation apparatus may be modular. That is, it may be in the form of detachable or releasable modules which may be assembled to one another at suitable stages. The modules may include the turbine head unit, a pylon unit, and a base or support unit. The turbine head unit may be detachably or releasably mounted to the pylon unit. Furthermore, the pylon may be detachably or releasably mounted to the base or support unit for supporting the pylon on a sea or other water body bed.

Preferably the generator is directly connected to one or more of the blade sets or rotor shafts. Preferably the generator is connected to the or each blade set or rotor shaft by a splined connection.

Preferably, the blade or foil speed is changed by changing the power load in the generator using a variable speed drive (VSD) positioned in association with the turbine or system. In one preferred arrangement, the VSD is located on the pylon or mounting structure of the power generating system. The VSD preferably controls and/or monitors power to the generator to affect load or torque.

Preferably, the instruction is selected from a group consisting of: increase torque, - decrease torque, alter direction of turbine, alter height of turbine, alter orientation of turbine, alter blade or foil angle, alter angle of attack, alter drive or VSD activity, couple or decouple generator, draw power from grid, send power to grid, and the like.

The blades may be splayed rearward from the blade root to the blade tip by a tilt -angle of about 1° to 20° from a plane perpendicular to the central axis.

Preferably the blades are splayed rearward from the blade root to the blade tip by a tilt angle of 2° to 10°, and more preferably by 4° to 6° from the plane perpendicular to the central axis. Further preferably, the blades are splayed rearward from the blade root to the blade tip by a tilt angle of about 5° from the plane perpendicular to the central axis.

The rotor preferably includes a nose cone mounted on the front of the rotor to reduce drag on the rotor and reduce turbulent water flow through the housing.

Preferably the nose cone is hollow to provide space for auxiliary systems such as control system or reservoirs for auxiliary or even primary systems.

In a preferred embodiment, the generator is housed with the rotor, the generator being adapted to generate electrical power from the rotation of the rotor. Preferably the generator is directly connected to a shaft. Preferably the generator is connected to the shaft by a splined connection.

Preferably, the generator is driven directly by the rotor, and this arrangement may suit the input speed required by selected generators such as multi-pole or high-pole electric generators. However, in some arrangements it may be suitable to connect a gearbox to the shaft or generator so that the rotation speed of shaft input to the generator is converted to a rotation speed that suits other types of generator.

Further, it will be appreciated that any blade shape is suitable and that a downstream or rearward tilt or rake angle of 1° to 20° can improve the power output of a central axis turbine having a suitable housing compared with the same turbine with a rake angle of 0° (i.e. with no rake or tilt). The blades can be an aerofoil, or tapered or trapezoidal, rectangular, parallel, curved or twisted. In preferred arrangements the aerofoil shape is a NACA 4412 series cross-sectional shape.

The blades may be bidirectional blades which may be symmetrical in section, with a slight symmetrical twist. Preferably the twist is between 5 and 35° and preferably 14°.

Preferably a brake is provided, in use to inhibit rotation of the rotor. Preferably the brake is a fail-safe mechanism. Preferably in use a braking actuator holds a brake element remote from the rotor against an actuation force when power is applied to the brake element. In use, when power is removed from the braking actuator, the actuation force, which may be from a spring or utilising some appropriate other kind of urging force, overcomes the braking actuator's force and applies the braking element to the rotor, slowing or stopping the rotation of the rotor.

Preferably a boot or a plug is provided at the blade root to cover any gaps or bumps or bolt heads and the like to minimise interference drag in that region.

Preferably, the housing defines a flow channel having a flow restriction from an opening forward of the rotor to a narrower throat adjacent the turbine body. Advantageously, this arrangement increases the velocity of liquid flowing through the flow channel in a restricted part of the flow channel, relative to an unrestricted part of the flow channel. The flow restriction preferably comprises a venturi, which may form part or the entire flow channel. In particular, the venturi may comprise a divergent-convergent-divergent venturi, tapering from openings at either end of the flow channel towards an inner part of the flow channel.

Preferably the housing is substantially symmetrical about the rotor.

The venturi may comprise at least one first frusto- conical, frusto-pyramid or horn shaped body, optionally a cylindrical body, and an at least one second frusto- conical, frusto-pyramid or horn shaped body.

In a preferred embodiment, the housing extends rearward of the rotor and acts as a diffuser, the housing diverging from the throat to a rear opening rearward of the rotor.

Preferably, the rotor supports at least two blades. Further preferably, the turbine has either 3 or 6 blades. It will be appreciated, however, that any number of blades of 2, 3, 4, 5, 6 or more can be used with the turbine.

In a second aspect, the present invention provides a method for controlling operation of an underwater power generator having a plurality of blades or foils which move in response to water flow the method comprising the steps of:

measuring selected properties of the generator or surrounding flow associated with blade or foil speed and inward water flow of the underwater power generator;

processing the measurements to calculate a Tip Speed Ratio (TSR or λ);

instructing a drive to change the blade or foil speed in response to the calculated TSR or λ.

In a third aspect, the present invention provides a data processing apparatus for controlling operation of a water turbine comprising:

a central processing unit (CPU);

a memory operatively connected to the CPU, the memory containing a program adapted to be executed by the CPU, wherein the CPU and memory are operatively adapted to receive information from meters for measuring or indicating selected properties associated with blade speed and inward water flow of the underwater power generator, calculate a Tip Speed Ratio (TSR) and send an instruction to a drive to change the speed of a blade or foil.

Preferably, the data processing apparatus further stores the information received on the activity affecting operation of a turbine, information received and / or information on the output or operation of the turbine.

Preferably, the data processing unit is a programmable logic controller (PLC).

In a fourth aspect, the present invention provides a data processing apparatus for controlling operation of an underwater power generator comprising:

a central controller including a central processing unit (CPU) and memory operatively connected to the CPU.;

at least one terminal, adapted for communicating with the central controller for transmitting information from meters for measuring or indicating selected properties associated with blade or foil speed and inward water flow of the underwater power generator;

the memory in the central controller containing a program adapted to be executed by the CPU, for receiving information relating to the tachometer output and flow meter output, calculating a Tip Speed Ratio (TSR or λ) and sending an instruction to the terminal to change the blade speed in response to the calculated TSR or λ.

Preferably, the apparatus contains a plurality of terminals with each terminal in communication with a separate turbine or collection of turbines.

Preferably, the central controller further stores the information received on the operation of a plurality of turbines.

The central controller may be hardwired to the terminals or in remote access by telephone, radio or the like.

In a fifth aspect, the present invention provides a method for controlling operation of an underwater power generator with the aid of a computer comprising:

receiving information from meters for measuring selected properties associated with blade speed and inward water flow of the underwater power generator;

analyzing the received information to calculate a Tip Speed Ratio (TSR or λ); and

sending an instruction to a drive based on the calculated TSR or λ to alter the blade speed.

In a sixth aspect, the present invention provides a computer readable memory, encoded with data representing a programmable device, comprising:

means for receiving information from meters for measuring or indicating selected properties associated with blade speed and inward water flow of the underwater power generator;

means for analyzing the received information to calculate a Tip Speed Ratio (TSR or λ); and

means for sending an instruction to a drive based on the calculated TSR or λ to alter the blade speed.

In a seventh aspect, the present invention provides a computer program element comprising a computer program code to make a programmable device:

receive information from meters for measuring or indicating selected properties associated with blade speed and inward water flow of the underwater power generator;

analyze the received information to calculate a Tip Speed Ratio (TSR or λ); and send an instruction based on the calculated TSR or λ to alter a blade speed.

In an eighth aspect, the present invention provides method of generating power from flow of water comprising:

installing an underwater power generator in a region having flowing water;
providing the system for controlling operation of an underwater power generator according to the first or second aspects of the present invention for the underwater power generator;
allowing flow of water to turn the underwater power generator; and
altering the power output of the underwater power generator using the controlling system to produce electricity from the underwater power generator.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of the invention disclosed in this specification.

In order that the present invention may be more clearly understood, preferred embodiments will be described with reference to the following drawings and examples.

### BRIEF DESCRIPTION OF THE DRAWINGS

FIG. 1 shows schematic of a control system for a water turbine according to a preferred embodiment of the present invention.

FIG. 2 shows schematic of another control system for a water turbine according to a preferred embodiment of the present invention;

FIG. 3 is a schematic diagram showing components of a control system of one preferred embodiment of the present invention;

FIG. 4 is a schematic diagram showing components of a control system of a preferred embodiment of the present invention; FIG. 5 is a schematic diagram showing components of a processing system; and

FIG. 6 is a perspective view of a suitable underwater power generator which is suitable for use with preferred embodiments of the present invention.

### DETAILED DESCRIPTION OF THE PREFERRED EMBODIMENTS

Underwater power generation systems typically contain a turbine having a number of blades or foils. The system also usually includes a power extraction device such as a generator or pump to generate power and rotation or movement of the blades or the foils under the influence of water pressure or lift causes power to be generated through the power extraction device. In its simplest form, rate of movement or rotation of the turbine is proportional to the movement or flow rate of the water that passes over or through the turbine. If the flow rate is too low, then the turbine will not function and no power is generated. Similarly, if the flow rate is irregular or inconsistent, the rate of power generation will also be irregular or inconsistent.

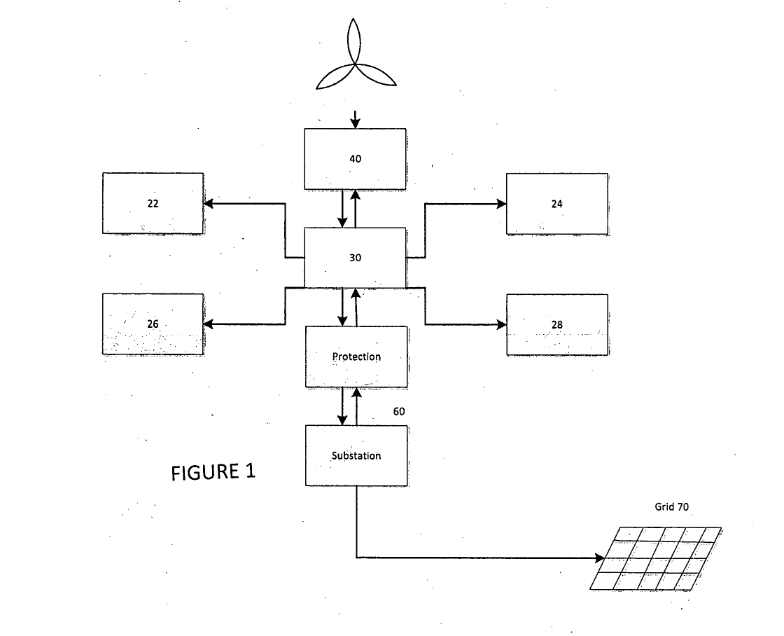

An example of the system for controlling operation of a water turbine according to a preferred embodiment of the present invention is set out in FIG. 1. Underwater power generator 40 is connected to power grid 70 and is capable of generating electricity and transferring the electricity via link 60 to the power grid 70. The underwater power generator or turbine 40 can be any suitable arrangement that can operate under the influence of water movement. Examples include, but not limited to central axis turbines as described herein and track-based turbines such as those described in WO 2005/028857, WO 2005/119052 and WO 2007/070935 (Atlantis Resources Corporation Pte Limited), as well as slew-ring turbines.

It should be noted that in preferred embodiments of the present invention, a plurality of blades are associated with the turbine 40 and these blades may be variable as to angle of attack or pitch but are preferably fixed in place (in terms of pitch or angle of attack) so as to simplify manufacture and increase reliability of the system. Therefore the control system of preferred embodiments of the present invention is important, since operating efficiencies are not easily affected in other ways.

The operation of the turbine 40 is carried out by control system 30 which receives and processes information from a number of meters 22, 24, 26, 28. Examples of the meters 22, 24, 26, 28 include flow meters, water flow direction meters, ammeters and voltmeters for measuring turbine load or output, tachometers for measuring turbine speed and/or blade speed, transducers for measuring angle of attack of turbine blades or foils, and the like. It should be noted that blade speed may be measured or indicated by various means, including an ammeter, voltmeter, power meter or ohmmeter placed on a generator, turbine, hub or other machine. Specific meters or apparatus to make the measurements can be placed in the immediate environment of the turbine 40 and relay those measurements or information to the control system. Information from the devices or meters 22, 24, 26, 28 are fed to control system 30 and output of the turbine 40 is controlled on the basis of the information processed. Specific software has been developed that allows information to be processed and signals or instructions sent to the turbine 40 to optimize its output in a given environment.

In particular, the software takes information from the tachometers and the flow meters or other meters (such as ammeters or voltmeters associated with the turbine or generator or rotor) to calculate a Tip Speed Ratio (TSR or λ). The TSR is a ratio of a blade tip speed to a water flow speed. If the blades rotate (in the case of a central axis turbine) or move (along a track, say) too slowly, most of the water will pass the blades without the harnessing of any energy therefrom. If the blades rotate or move too fast, the blades prevent the flow of water past the blades and thus cannot harness energy efficiently therefrom. The present inventors have found that calculating the TSR and maintaining that flow-by quantity in a selected range for underwater power generators improves efficiency of the power generator across a larger range of flowrates. The TSR varies according to various factors including blade number for central axis water turbines but it is envisaged that it should be between 2 and 6, and preferably about 4.2 for a three bladed underwater turbine.

In one example, the preferred control system 30 has a programmable logic controller (PLC) which is associated with the turbine 40 which includes a drive in the form of a variable speed drive (VSD) adapted to control the rotational speed of the motor/generator unit on the turbine in order to provide optimum power output. The PLC is adapted to regulate the operating speed and torque of the turbine 40 using the VSD, so as to maintain optimum power output for a given water flow rate.

The system may further include a kick start function to initiate or increase rotation of the turbine when flow rate is low or to overcome resistance to rotation of the turbine under high or low input situations.

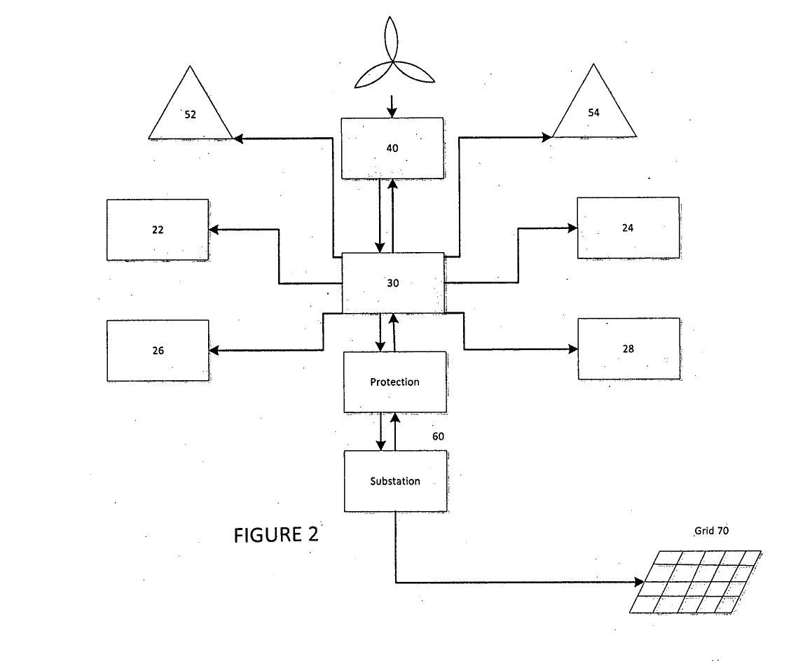

FIG. 2 shows a similar arrangement to the system of FIG. 1 but further includes other examples of external drives or altering means 52 and 54 for turbine 40. Examples of altering means 52 and 54 include devices and drives for positioning turbine 40 relative to water flow direction, adjusting height or depth of turbine 40, altering rotor blade or foil speed of turbine 40, altering power load or torque applied to turbine 40. As described above, a variable speed drive (VSD) can be used to apply torque or anti-torque to the turbine 40 to maintain the desired movement to optimize power generation, generally depending on the calculated TSR relative to the optimal TSR.

For turbines that require specific positioning regarding the direction of water flow, such as for example track-based systems, an altering means can be a slewing arrangement to focus or aim the turbine 40 relative to water flow direction.

The system may further include a kick start function to initiate or increase rotation of the turbine when flow rate is low or to overcome resistance to rotation of the turbine under high or low input situations. In this regard, power would be drawn from the power grid 70 to turn the turbine 40 by a motor arrangement. Some forms of generators can generate power via rotation of the turbine 40 but can also be used as a motor to turn a turbine 40 via power received form the power grid 70. The control system 30 can control supply of electricity to or from the generator as required.

The control system 30 can be placed in close proximity to the system 10 and be hardwired to the devices or meters or measuring means 22, 24, 26, 28, drives or altering means 52, 54 and turbine 40. Alternatively, the control system 30 can be remote and in communication by radio network or other communications network such as for example the internet. The control system 30 can control a single turbine or operate a series of turbines in a water turbine farm.

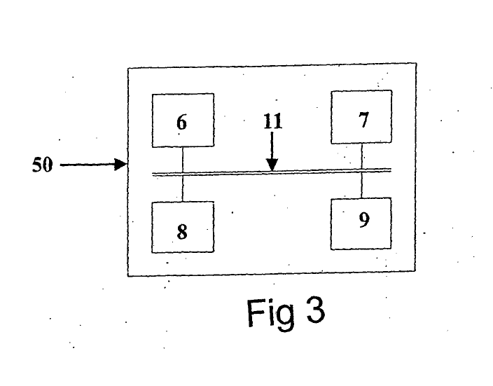

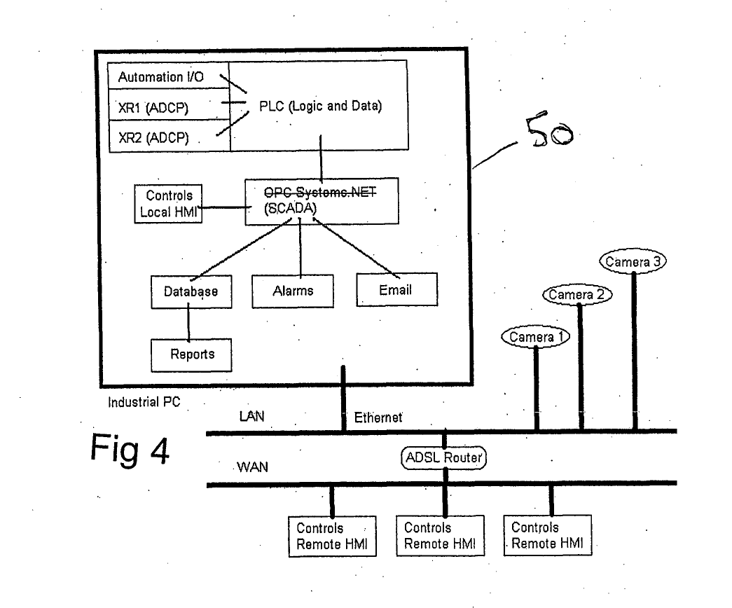

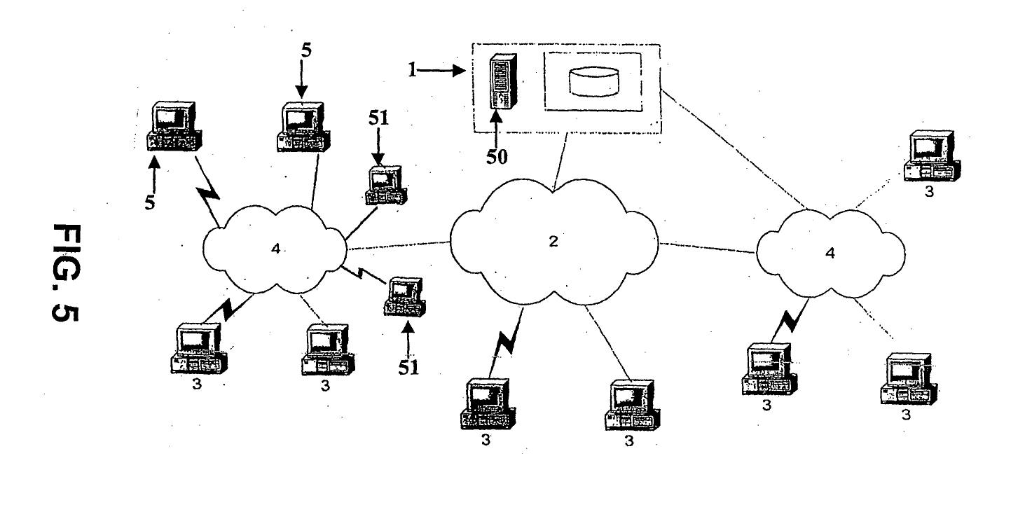

The control system 30 may include a processing system 50 which includes a distributed architecture, an example of the latter being shown at FIGS. 3, 4 and 5. In this example, a base station 1 is coupled to a number of end stations 3 and 5 via a communications network 2, such as for example the Internet, wired and/or wireless or radio networks, and/or via communications networks 4, such as local area networks (LANs) 4. Thus it will be appreciated that the LANs 4 may form an internal network at a specific location.

In use, the processing system 50 is adapted to receive information from at least the meters 22-26 and/or other means such as websites or control inputs, and supply this to the end stations 3, 5 in the form of a user or controller's terminal. The or each end station 5 is adapted to provide information back to the base station 1.

Accordingly, any form of suitable processing system 50 may be used. An example is shown in FIG. 3. In this example, the processing system 50 includes at least a processor 6, a memory 7, an input/output device 8, such as for example a keyboard and display, and an external interface 9 coupled together via a bus 11 as shown.

Accordingly it will be appreciated that the processing system 50 may be formed from any suitable processing system, such as for example a suitably programmed PC, PLC, internet terminal, laptop, hand held PC or the like which is typically operating applications software to enable data transfer and in some cases web browsing.

Similarly the or each end station 3 must be adapted to communicate with the processing system 50 positioned at the base station 1. It will be appreciated that this allows a number of different forms of end station 3 to be used.

The preferred embodiments are operated such that there are three bands of operation:

First, Band 1 is a band in which it is not worth operating the turbine at all because the water flow past the blades is too low. This is a band, generally speaking, in which water flow measured by the flow meter is lower than 1 knot. It should be noted that it would be possible to measure the output from the tachometer and the water flow meter, process those numbers with the CPU to provide a TSR and compare it with an optimum TSR. With such a low flow rate, the optimum TSR is likely to be higher than that calculated: Then, the VSD could be engaged to increase hub rotation or blade speed, but the energy required to increase the rotation or blade speed would be more than that which is generated. Therefore, in Band 1, the generator may be disconnected from the turbine or the brake is applied, or a turbine body upon which a rotor having blades is mounted, is slewed or yawed to change its angle of attack out of the flow of water.

Band 2 is a band within which the turbine is operated. Generally speaking, the flow meter measures 1-8 knots in this band. In this band, the same steps are taken to operate the turbine as described above, however, the VSD increases or decreases the speed of the blades until the TSR reaches as close as possible to the optimal ratio for the system. That is, in this Band, the VSD improves efficiency of the system and the energy cost for this improvement, whether the VSD has to increase or decrease the blade speed, is less than the energy generated or the increase in the energy generated.

Band 3 is a band of operation where the flow meter measures, say, 8-15 knots. The VSD is employed to reduce the efficiency of the system, by reducing the speed of the blades. In this situation the system is driven to perform poorly in terms of efficiency.

This is because if the system were to perform well on this measure, the blades and the associated turbine may actually destroy the generator by forcing it to output more power than that for which it is rated.

For flows above, say, 15 knots, an emergency brake is applied to reduce the possibility of damage to all components.

Meters or inputs 22, 24, 26, 28 may also include cameras or other detection means such as sonar and those inputs as herein described on the pages of this specification. Sonar and underwater and above-water cameras can be utilised and their outputs can be remotely monitored over the communications network. In this way, certain kinds of obstruction can be detected by an operator or computer who can remotely stop the turbine or alter the turbine performance in some appropriate manner. The detection means, sonar or cameras may also be connected to an alarm and an emergency automatic stop. Software such as for example shape recognition software can also be utilised so that potential obstructions can be automatically detected, and the control system 30 can then actuate certain other devices automatically in response. In certain circumstances, action can be taken by the control system 30 in response to certain potential hazards, such as the actuation of an alarm or a change in the operating speed or angle or height of the turbine 40, until the potential or actual obstruction has been removed or has removed itself. At that time the absence of the obstruction can also be detected by the cameras or sonar or other detection means and the turbine 40 can be actuated automatically to recommence generation of power.

Furthermore, footage from the camera or the events from the sonar can be recorded by the memory. For increased efficiency of data storage, other time periods where no events occur may be deleted from memory, however, a selected time period before and after an obstruction event may be retained in the memory for later review.

Inputs 22, 24, 26, 28 may also include current profilers in the form of Acoustic Doppler Current Profilers (ADCPs) which report to the control system 30 the following information:

10 laminar water layers of water velocity

10 laminar water layers of water direction

Average water velocity

Average water direction

Tide depth

The abovementioned information is logged to an SQL server database.

The ADCPs are integrated into a PLC control system and their outputs may be utilized in the processor so that it, through an actuation signal, causes actuation of an element such as a hydraulic motor so that the height or yaw angle of the turbine 30 may be changed to optimise output. If the tide reverses direction the control system makes what is known as a Major movement (180 degrees rotation) and if the tide changes direction by a few degrees the control system makes what is known as a Minor movement to optimise the power output.

The control system also maintains secure access to all outputs. Access to the control system is password-protected, which in preferred embodiments is useful because the communications network facilitates access from anywhere the internet or other satellite-enabled communication device is disposed.

The control system 30 monitors and controls various levels of power including PLC links to relays for various devices, fuses and switches, and also controls and monitors high-voltage outputs to control the phase angles and magnitudes of power entering the power grid 70.

In order to increase reliability, 24V circuits are preferably employed in computing circuits, UPS, sensors and I/O controls. Furthermore, redundant power supplies are installed in the control system 30. Each power supply is connected to a Diode module and if one power supply fails or faults, this fault condition is contained behind the diode module allowing the other power supply to continue operating. Each power supply has a fault signaling contact wired into the PLC I/O so notification of the fault can be detected and repaired.

Fuses can be reset remotely by PLC outputs. This is useful in preferred embodiments because they are usually located in a cabinet in a remote location offshore on a pylon or in a nacelle adjacent the turbine or generating unit.

Power supplies are provided, in the form of batteries which can be recharged by a solar panel or other method such as tapping the tidal power from the turbine 40.

The control system may also generate reports upon request relating to tidal flow; tidal angle, power generated, events log.

Other measuring means connected to the PLC include flooded motor chamber detector; thermocouple for motor temperature; thermocouple for air temperature; tachometer for turbine, devices for measuring motor torque, frequency, volts, amps, power, RPM. The PLC is also connected to the hydraulic motors which move the turbine along the pylon and around the pylon. Positioning measuring devices are also connected so that accurate readings and positions can be obtained.

Software provides a Graphical Interface so as to provide the following information and capability to any user or controller location in the world: data from power generation; manual override of torque setting; manual override of height and angle of turbine 40; views of real-time power generation statistics; views of previous time-periods of power generation; views of camera images; views of tide tables; views of tide laminae in real time; alarm log.

It is possible for this control system to be utilised with any suitable kind of underwater power generator. However, hereinbelow is described one suitable power generation apparatus for the purposes of improving understanding. It is to be understood that many differing kinds of underwater power generator are contemplated and suitable for use with the abovedescribed control system.

The underwater power generator shown at 110 includes a turbine head unit 105 having a central longitudinal axis 111, and further comprising a turbine comprising a first blade set or rotor 112 rotatably mounted for rotation in response to incident water flow disposed at a first end 113 of the power generation apparatus 110 and a second blade set or rotor 114 at a second end of the power generation apparatus 110 similarly rotatably mounted. A generator 134 is disposed between the first and second blade sets. The power generation apparatus 110 is generally installed so that the central longitudinal axis 111 extends in a direction parallel with a water flow direction.

In use, the second rotor 114 is disposed in a downstream position relative to the first rotor 112. Furthermore, the second rotor 114 is disposed coaxially and directly downstream of the first rotor 112 and in the wake zone of the first rotor 112.

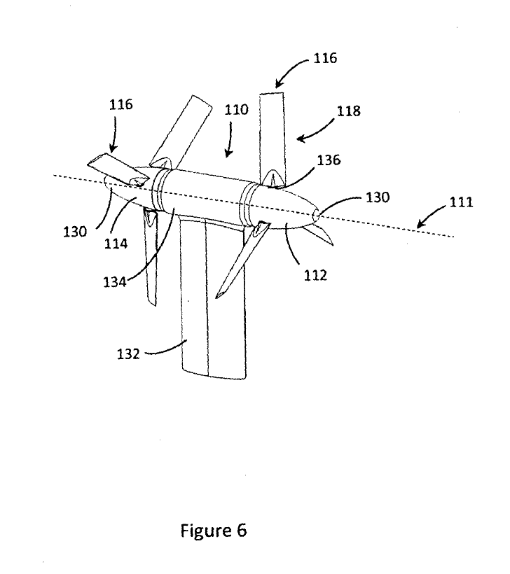

The first and second blade sets or rotors 112, 114 include blade arrangements or blade sets 116 integral with or mounted thereon and which comprise a plurality of blades 118. The blades 18 may be any type of blade, and in one arrangement the blades 118 are uni-directional (as shown in FIG. 6). These blades show a high degree of twist as abovedescribed. The rotor shown in FIG. 6 may be used so that the blade sets face outwards as shown at each end, or one may face inwards. Alternatively, the pitch of the blades is variable and completely reversible.

Preferably, however, the blades 118 are bidirectional (cf all other Figures, but in detail shown in FIG. 6) so that the blades may work as well if the water strikes the blades from one side or the other.

Although in operation the wake zone is a disturbed flow zone, the second blade set may be advantageously utilised to increase the efficiency of the energy harvest from that wake zone. However, when sited in reversing flows, the generation apparatus 110 may be arranged so that both the first and second bladesets are adapted to be upstream bladesets. In the case of monodirectional blades this arrangement may be such that the blades are reversibly mounted relative to one another. Thus, in one arrangement the blades would be such that each blade would be angled towards the generator a selected rake angle as abovedescribed. It may also be in that situation that the trailing bladeset is locked or free to rotate, since that bladeset may not improve the overall efficiency of the generating machine when run effectively backwards. However, it is also possible and contemplated that both bladesets are arranged so that the second bladeset is designed to be always a downstream bladeset and thus would be disposed similarly to the upstream bladeset (ie in the case of a rake, if that is most efficient, both rakes would be at corresponding angles to one another ie both raked in the same direction). This latter arrangement would most likely require a rotating turbine head.

The blades 118 are mounted on each rotor and disposed thereabout at equal angular spacings. There are three blades 118 provided per rotor. The blades 118 on the second rotor 114 are disposed so that they are in a staggered position relative to the blades on the first rotor 112, when the rotors are mounted on a common shaft (not shown) so that one blade is not shadowed by another blade when in use.

The rotors 112, 114 may be mounted on a common shaft as discussed above, or may be mounted on separate or operatively linked shafts. The shafts may be linked by a gearbox to increase or decrease the relative speed of the second rotor 114 relative to the first rotor 112 if required for increased efficiency. The rotors 112, 114 shown, however, are used in the preferred embodiments of turbine 110, and are mounted on the same shaft with an interference fit or a splined connection (all not shown), but which in either or any case, fix the rotating speeds of the rotors 112, 114 to be common with one another and maintains the angular staggering of the blades 118 between the rotors 112, 114.

The blade sets or rotors 112, 114 may be selectively uncoupled so that one blade set freely rotates relative to the other and a brake may be provided to selectively lock one blade set or the other. It is also possible to operatively connect the two blade sets or rotors so that they rotate in opposite directions from one another.

The power generation apparatus 110 may be provided with a rotation unit (not shown), which may rotate the unit up to 180 degrees, which is more valuable when the turbine 10 is installed with uni-directional blades 118, but may be of some use when fitted with bidirectional blades 118. For example, the power generation apparatus 110 may be turned so that the central axis may move a few degrees, up to, say, 45°, so as to align the central axis with the water or current flow, which may move several degrees between or within cycles, for improved efficiency.

The first and second blade sets or rotors 112, 114, are separated a suitable downstream distance, which testing to date has indicated is about the same distance as the diameter (d) of the blades 118. Other downstream separation distances have been modelled and useful efficiencies have resulted when the separation distances are between about 0.1 d and 10 d.

Nose cones 130 are provided so as to promote or assist flow attachment.

The power generation apparatus 110 may include a pylon 132 upon which the turbine head unit 105 including a generator 134 is mounted. The pylon 132 may be streamlined so as to reduce water flow stresses on the pylon. The pylon 132 may include a releasable mount so as to releasably support the turbine head unit 105. The pylon 132 may also be releasably mounted at its base to a support base unit which is in the form of a base platform and includes recesses for receiving spoil, concrete or other masses to stabilise the base on the ocean floor.

The present inventors have extensively modelled the power output of water turbines such as for example the one described hereinabove, as well as one with just one bladeset on a single pylon and have developed suitable control systems 10 based on this information. It has been found that even subtle or sensitive manipulation of environmental factors can allow optimum power generation, even from low water flow rates. A set point can be calculated for a given flow rate and type of turbine so that the control system 10 can be programmed to maintain the speed of turbine to maximize output in that flow rate.

Preferred embodiments of the present invention have been used by the applicant to successfully control and optimize the power generation of a track-based water turbine connected to a power grid.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for controlling operation of an underwater power generator, the system comprising:
meters or devices for measuring selected properties associated with blade speed and inward water flow of an underwater power generator;
a drive for altering one or more selected aspects of operation of the underwater power generator; and
a data processing apparatus comprising a central processing unit (CPU), a memory operatively connected to the CPU, the memory containing a program adapted to be executed by the CPU, wherein the CPU and/or memory are operatively adapted to receive information from the meters to calculate a Tip Speed Ratio (TSR or λ) and implement an instruction to the drive to change the one or more selected operating parameters of the underwater power generator in response to the calculated TSR or λ.

2. The system in accordance with claim 1 wherein the meters are selected from the group consisting of tachometer, flow meter, ammeter, voltmeter, power meter, ohmmeter, Acoustic Doppler Current Profiler, strain gauge, transducer, and thermocouple.

3. The system in accordance with claim 1 wherein the system includes a turbine which is a track-based, slew-ring or central axis type of turbine.

4. The system in accordance with claim 1, wherein the drive is selected from the group consisting of a variable speed drive for changing the blade rotational speed, a hydraulic motor for changing a yaw angle or height of the turbine above sea bed level, a generator or inverter to change a torque input to the turbine to affect its speed, and an alarm.

5. The system in accordance with claims 1 wherein the underwater power generator is in the form of a central axis water turbine which includes:
a generator;
a first blade set operatively mounted to the generator for rotation in a selected direction in response to flowing water from a selected direction; and
a second blade set operatively mounted to the generator for rotation and operatively connected to the first blade set, the second blade set being disposed coaxially with, and downstream of or in a wake zone of, the first blade set;
wherein the generator is adapted to be driven by at least one of the blade sets, and the generator disposed generally coaxially between the first and second blade sets.

6. The system in accordance with claim 5 wherein a clutch or braking arrangement is provided in order to uncouple or, in the alternative, lock the first blade set from the second blade set.

7. The system in accordance with claim 5 wherein a coupling apparatus may be provided between the blade sets which drives the second blade set in an opposite direction to that of the first blade set.

8. The system in accordance with claim 1 wherein in operation the blade or foil rotational speed is changed by changing the power load in the generator using a variable speed drive (VSD) positioned in association with the turbine or system.

9. A method for controlling operation of an underwater power generator having a plurality of blades or foils which move in response to water flow the method comprising the steps of:
measuring selected properties of the generator or surrounding flow associated with blade or foil speed and inward water flow of the underwater power generator;
processing the measurements to calculate a Tip Speed Ratio (TSR or λ; and
instructing a drive to change the blade or foil speed in response to the calculated TSR or λ.

10. A data processing apparatus for controlling operation of a water turbine comprising:
a central processing unit (CPU); and
a memory operably connected to the CPU, the memory containing a program adapted to be executed by the CPU, wherein the CPU and memory are operably adapted to receive information from meters for measuring or indicating selected properties associated with blade speed and inward water flow of the underwater power generator, calculate a Tip Speed Ratio (TSR) and send an instruction to a drive to change the speed of a blade or foil.

11. A data processing apparatus for controlling operation of an underwater power generator comprising:
a central controller including a central processing unit (CPU) and memory operably connected to the CPU;
at least one terminal, adapted for communicating with the central controller for transmitting information from meters for measuring or indicating selected properties associated with blade speed and inward water flow of the underwater power generator;
the memory in the central controller containing a program adapted to be executed by the CPU, for receiving information relating to the tachometer output and flow meter output, calculating a Tip Speed Ratio (TSR or λ) and sending an instruction to the terminal to change the blade speed in response to the calculated TSR or λ.

12. A method for controlling operation of an underwater power generator with the aid of a computer comprising:
receiving information from a tachometer relating to speed of a blade associated with the underwater power generator and information from meters for measuring or indicating selected properties associated with blade speed and inward water flow of the underwater power generator;
analyzing the received information to calculate a Tip Speed Ratio (TSR or λ); and
sending an instruction to a drive based on the calculated TSR or λ, to alter the blade speed.

13. A computer readable memory, encoded with data representing a programmable device, comprising:
means for receiving information from a meters for measuring selected properties associated with blade speed and inward water flow of the underwater power generator;
means for analyzing the received information to calculate a Tip Speed Ratio (TSR or λ); and
means for sending an instruction to a drive based on the calculated TSR or λ, to alter the blade speed.

14. A computer program element comprising a computer program code to make a programmable device:
receive information from a meters for measuring or indicating selected properties associated with blade speed and inward water flow of the underwater power generator;
analyze the received information to calculate a Tip Speed Ratio (TSR or λ; and
send an instruction based on the calculated TSR or λ, to alter a blade speed.

15. A method of generating power from flow of water comprising:
installing an underwater power generator in a region having flowing water;
providing the system for controlling operation of an underwater power generator according to claim 1 for the underwater power generator;
allowing flow of water to turn the underwater power generator; and
altering the power output of the underwater power generator using the controlling system to produce electricity from the underwater power generator.
